(19) United States
(12) Patent Application Publication
(10) Pub. No.: US 2002/0119798 A1
(43) Pub. Date: Aug. 29, 2002

(54) Mobile communication system, transmission power control method therefor, and base station used therefor

(75) Inventor: Kojiro Hamabe, Tokyo (JP)

Correspondence Address: SUGHRUE MION, PLLC, 2100 PENNSYLVANIA AVENUE, N.W., WASHINGTON, DC, 20037, US

(73) Assignee: NEC CORPORATION

(21) Appl. No.: 10/082,075

(22) Filed: Feb. 26, 2002

(30) Foreign Application Priority Data
Feb. 28, 2001 (JP) 2001-053453

(51) Int. Cl. H04Q 7/20

(52) U.S. Cl. 455/522; 455/13.4

(57) ABSTRACT

A sum of transmission powers for all channels for transmissions from a base station to mobile stations is controlled to constant. Specifically, the transmission power for a high speed and high capacity shared channel is controlled such that a sum of transmission powers for individual channels for individual mobile stations, and the shared channel is always constant. With this constitution, an interference wave power from neighboring cells becomes constant, an average data transfer rate of the shared channel becomes constant, a prediction precision for a wait time for sending/receiving data increases, a lower limit for an actual data transfer rate becomes high, and the number of users in a service quality assurance type service increases. Additionally, when the number of individual channels in use is low, the transmission power for shared channel can increase, and the transmission rate increases and the time decreases when a best effort type service is provided.

### BACKGROUND OF THE INVENTION

1. Technical Field of the Invention

The present invention relates to a mobile communication system, a transmission power control method for the mobile communication system, and base station used for the mobile communication system, and specifically relates to a transmission power control method for a base station in a mobile communication system including a base station, and a mobile station where both of or either one of an individual channel, and a shared channel shared with other mobile stations for transmitting data from the base station are set with the base station.

2. Description of the Related Art

Multi media readiness has been in progress for handling large amount of still pictures and short motion pictures on mobile terminals (mobile stations) such as cellular phones recently. There is HSDPA (High Speed Downlink Packet Access) method as a high capacity/high speed data transmission method, and a data transmission method such as HS-PDSCH (High Speed-Physical Downlink Shared Channel) which increases only a transmission speed on a downlink (from a base station to a mobile station) is under consideration.

As described above, when a large amount of data are transmitted through a communication network from a base station to a mobile station, a high speed down link shared channel referred to HS-PDSCH (a dedicated downlink line) is used to transmit data divided into packets, and when it is necessary to simultaneously transmit large amount of data to multiple mobile stations, this high speed down link shared channel referred to HS-PDSCH is time-shared (time sharing) to share the one high speed channel.

A transmission power for the shared channel is set to constant to restrain an interference wave power influencing the other users in a transmission power setting method for the HS-PDSCH (high speed shared channel) from a base station in the conventional HSDPA.

In this way, while the transmission power for shared channel is set to constant to restrain the interference wave power influencing the other users in the conventional HSDPA, there is a problem that a fluctuation of a transmission power for another channel fluctuates the interference wave power on the other users when multiplexed with the channel.

The following section details while referring to FIG. 1. Base stations 1 to 3 are base stations neighboring to one another, and the individual base stations 1 to 3 respectively have cells 4 to 6 as service areas in FIG. 1. These base stations 1 to 3 are connected with a communication network suppressed from the drawing through a base station control station (RNC: Radio Network Controller) 7. There exist multiple mobile stations inside the cells 4 to 6 as the service areas of individual base stations, and multiple mobile stations 8a to 8e exist only in the cell 4 of base station 1 in FIG. 1 for simplicity.

When CDMA (Code Division Multiplex Access) is used as a wireless access in this system, because the same frequency is shared among the neighboring cells 4 to 6, maintaining a transmission power of the HS-PDSCH constant maintains an interference wave power received from cells around constant.

However, an individual (physical) channel for an uplink/downlink referred to a DPCH (Dedicated Physical Channel) may be simultaneously set on a frequency carrier the same as that for setting the HS-PDSCH. This DPCH is an individual channel dedicated for the mobile station, and used for a service for transmitting information continuously at an approximately constant transmission rate such as a voice phone and a TV phone, and is a channel individually set between the base station 1 and the individual mobile stations 8a to 8e in FIG. 1.

Because channel number set for the DPCH changes over time according to the number of mobile stations which receive a service, and a transmission power for the DPCH is controlled so as to maintain the communication quantity constant, the transmission power for DPCH for the downlinks from the base station to the individual mobile stations changes over time. Thus, a transmission power for the overall frequency carriers becomes an example shown in FIG. 2, and the total transmission power transmitted from the base station changes over time. CPICH means a common pilot channel common to all the mobile stations in FIG. 2, and the transmission power for it is constant as shown in FIG. 2.

In this way, because the total transmission power transmitted from the base station changes, the interference wave power received from the neighboring cells is not constant, and consequently, there is a problem that an average data transmission rate for the transmission using the HS-PDSCH is not constant.

There are a best-effort type service which increase the transmission rate in a possible range, and decreases a delay time, and a service quality assurance type service which assures the quality of a service such as an average transmission rate and the maximum delay time, and because the service quality assurance type service of them assures a user of a certain service quality, it has an advantage of limiting a wait timer for receiving and sending data to a certain period or less.

However, the average transmission rate is not constant because of the fluctuation of interference wave power received from the surrounding cells as described above, prediction precision for the wait time for transmitting and receiving data is low, the interference wave power received from the surrounding cells increases, and there is a problem that it is necessary to limit the number of users in the service quality assurance type service to low for assuring the service quality when the data transmission rate is low.

In addition, there is a certain upper limit for a total (a sum) of the transmission powers for HS-PDSCH and the entire DPCH as shown as a dotted line in FIG. 2. The indication includes the transmission power for CPICH in FIG. 2. A modulation/coding mode is switched according to a propagation path state to select a mode providing the highest transmission rate in a rage satisfying an expected communication quality (such as a block error rate) in the HS-PDSCH. Namely, when the transmission path state is favorable, 64 QAM (Quadrature Amplitude Modulation), for example, is selected, when the transmission path state degrades, a low speed type such as 16 QAM is selected, and when the transmission path state further degrades, a lower speed type such as QPSK (Quadrature Phase Shift Keying) is selected.

However, the conventional method maintains the transmission power for HS-PDSCH constant regardless of the channel number set for the DPCH. As a result, it is necessary to reserve a transmission power for a possible number of the DPCH channels to be set, and to use the remaining power for transmission power for the HS-PDSCH, and the transmission power for HS-PDSCH is restrained to low.

As a result, a higher speed mode is not used for the modulation/coding mode accordingly, and there is a defect that the average data transmission rate decreases.

Even when the number of DPCH channels in use is low, because the transmission power for HS-PDSCH is constant, an unavailing portion is present as shown in FIG. 2. Further, because the transmission power for HS-PDSCH is constant, and the data transmission rate cannot be largely increased, the transmission rate cannot be largely increased, and the delay time cannot be largely decreased when the best effort type service is provided.

### SUMMARY OF THE INVENTION

The object of the present invention is to provide a mobile communication system for providing a constant average data transmission rate transmitted using HS-PDSCH, a transmission power control method for the system, and a base station used for the system.

An alternative purpose of the present invention is to provide a mobile communication system for increasing the number of users for receiving a service quality assurance type service, a transmission power control method for the system, and a base station used for the system.

Another alternative purpose of the present invention is to provide a mobile communication system for increasing a transmission rate, and decreasing a delay time, a transmission power control method for the system, and a base station used for the system when a best effort type service is provided.

The present invention provides a mobile communication system comprising a base station, a mobile station having either one of or both of an individual channel set to the base station, and a shared channel set to the base station shared with other mobile stations for transmitting data from the base station, and a transmission power control device for controlling a sum of transmission powers from the base station to the mobile stations as approximately constant.

The transmission power control device is characterized in that it maintains a sum of transmission powers for the shared channel, and for the individual channels at the constant power, and sets the transmission power for shared channel to the constant power when there exists no individual channel. The transmission power control device is characterized in that it respectively increases/decreases the transmission power for shared channel according to an increased/decreased transmission power because of an increase/decrease of the individual channels, and respectively increases/decreases the transmission power for shared channel by an average transmission power of the individual channels for an increase/decrease of one individual channel.

The transmission power control device is characterized in that if the sum of transmission powers is larger than an upper limit, it decreases the transmission power for shared channel by a difference between the sum and the upper limit, and if the sum of transmission powers is lower than a lower limit, it increases the transmission power for shared channel by a difference between the sum and the lower limit.

The transmission power control device is characterized in that it is provided in the base station. The mobile communication system further comprises a base station control station for controlling the base station wherein the base station reports information for the transmission power control to the base station control station, and the base station control station notifies setting information on the transmission power for shared channel based on the reported information.

The present invention provides a transmission power control method for a base station of a mobile communication system including a base station, and a mobile station having either one of or both of an individual channel set to the base station, and a shared channel set to the base station shared with other mobile stations for transmitting data from the base station while comprising a transmission power control step for controlling a sum of transmission powers from the base station to the mobile stations to approximately constant.

The transmission power control step is characterized in that it maintains a sum of transmission powers for the shared channel, and for the individual channels at the constant power, and it sets the transmission power for shared channel at the constant power when there exists no individual channel. The transmission power control step is characterized in that it respectively increases/decreases the transmission power for shared channel according to an increased/decreased transmission power because of an increase/decrease of the individual channels, and it respectively increases/decreases the transmission power for shared channel by an average transmission power of the individual channels for an increase/decrease of one individual channel.

The transmission power control step is characterized in that if the sum of transmission powers is larger than an upper limit, it decreases the transmission power for shared channel by a difference between the sum and the upper limit, and if the sum of transmission powers is lower than a lower limit, it increases the transmission power for shared channel by a difference between the sum and the lower limit.

The transmission power control step is characterized in that it is conducted in the base station. The transmission power control method is characterized in that the mobile communication system further comprises a base station control station for controlling the base station, and it further comprises steps of reporting information for the transmission power control to the base station control station in base station, notifying setting information on the transmission power for shared channel based on the reported information in base station control station, and conducting the transmission power control according to this notified information in the base station.

The present invention provides a base station for setting either one of or both of an individual channel with a mobile station and a shared channel shared with other mobile stations for transmitting data to a mobile channel while comprising a transmission power control device for controlling the sum of transmission powers to the mobile stations to approximately constant.

The present invention provides a program for making a computer execute a process for a transmission power control method for a base station of a mobile communication system including a base station, and a mobile station having either one of or both of an individual channel set to the base station, and a shared channel set to the base station shared with other mobile stations for transmitting data from the base station while comprising a transmission power control step for controlling a sum of transmission powers from the base station to the mobile stations to approximately constant.

The following section describes an action of the present invention. The present invention controls such that the sum of transmission powers for all channels for transmitting from the base station to the mobile stations is approximately constant, and specifically controls the transmission power for high speed/high capacity shared channel (HS-PDSCH) such that the sum of transmission powers for the individual channels (DPCH) for individual mobile channels, and the shared channel is always approximately constant. As a result, the interference wave power from neighboring cells becomes constant, the average data transfer rate of shared channel becomes constant, prediction precision for a wait time for transmitting/receiving data increases, the lower limit for actual data transmission rate increases, and the number of users for the service quality assurance type service increases. Because when the number of individual channels in use is low, the transmission power for shared channel can increase, and the transmission rate increases and the time decreases when the best effort type service is provided.

### BRIEF DESCRIPTION OF THE DRAWINGS

FIG. 1 is a conceptual drawing for a mobile communication system;

FIG. 2 is a drawing for describing a downlink transmission power from a conventional base station;

FIG. 3 is a drawing for describing a principle of the present invention;

FIG. 4 is a flowchart for showing an operation of an embodiment of the present invention;

FIG. 5 is a block diagram for showing an embodiment of a base station of the present invention;

FIGS. 6A and 6B are format drawings of DPCH; and

FIG. 7 is a block diagram for showing an alternative embodiment of the base station of the present invention.

### THE DETAILED DESCRIPTION OF THE PREFERRED EMBODIMENTS

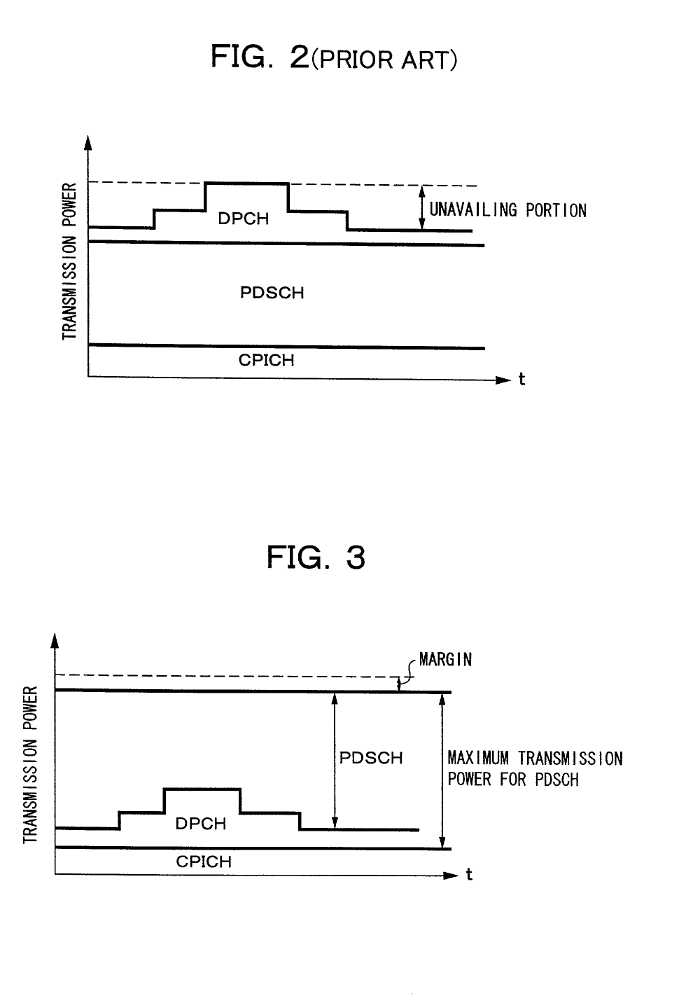

The following section describes preferred embodiments of the present invention while referring to drawings. FIG. 3 shows a conceptual drawing for describing a principle of the present invention, and the present invention controls such that a sum of downlink transmission powers for set channels for transmitting from a base station is always constant over time. CPICH is a common pilot channel in FIG. 3, and a transmission power therefor is always maintained constant as conventional cases (see FIG. 2). A transmission power of DPCH, which comprises individual channels for individual mobile stations, changes over time according to the number of mobile stations which receive a service as in the conventional cases (see FIG. 2).

The present invention differs from the conventional cases in that a transmission power for HS-PDSCH (abbreviated simply as PDSCH hereafter), which is a high speed/high capacity shared channel, is controlled according to a change of the transmission power for DPCH, and a sum of transmission powers for downlink channels from the base station is constant over time. It is also possible to set a constant margin (an allowance) for the sum of transmission powers shown as a broken line in FIG. 3. Namely, it is possible to set the maximum transmission power for PDSCH to a value indicated with the broken line in FIG. 3 while maintaining the margin.

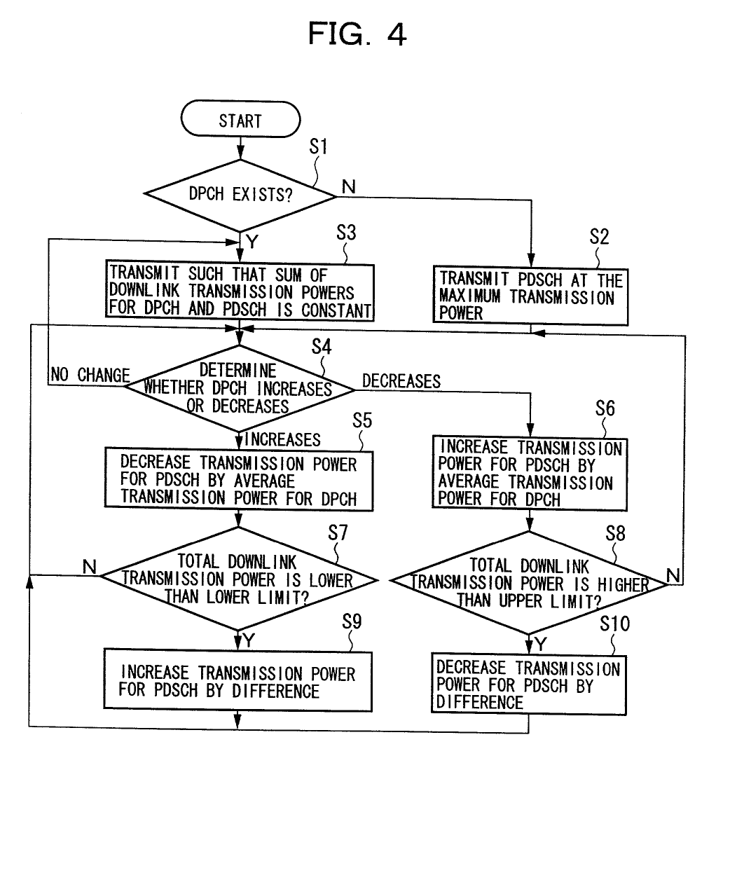

FIG. 4 is a flowchart for showing an operation of an embodiment of the present invention, and is an operation flow at the base station when the transmission power is controlled as shown in FIG. 3. First, it is determined whether the downlink DPCH setting exists or not (Step S1), and the PDSCH is transmitted at the maximum transmission power (see FIG. 3) if not (Step S2). If at least one channel is set for the DPCH, the transmission power for PDSCH is determined such that the sum of transmission powers for the DPCH and the PDSCH is constant (Step S3).

Then, it is determined whether the DPCH increases or decreases (Step S4), if the set channel number for DPCH increases, the transmission power for PDSCH decreases by a power corresponding to the increased channel number, and if the DPCH increases by (n) ((n) is an integer equal to or more than 1) channel, the transmission power for PDSCH is decreased by [(n)×(an average transmission power)] where the average transmission power for DPCH was measured, and determined empirically in advance (Step S5).

Inversely, if the set channel number for DPCH decreases, the transmission power for PDSCH increases by a power corresponding to the decreased channel number. In this case, if the decreased channel number for DPCH is (n), the transmission power for PDSCH increases by [(n)×(the average transmission power)] as well (Step S6).

A target range (an upper limit and a lower limit) for the total downlink transmission power is set, and as a result of the individual processes in Step S5 and Step S6, if the total downlink transmission power decreases below the lower limit, or increases over the upper limit (Step S7 and Step S8), the transmission power for PDSCH is controlled respectively to increase or decrease by the difference (the deficiency or the excess) (Step S9 and Step S10).

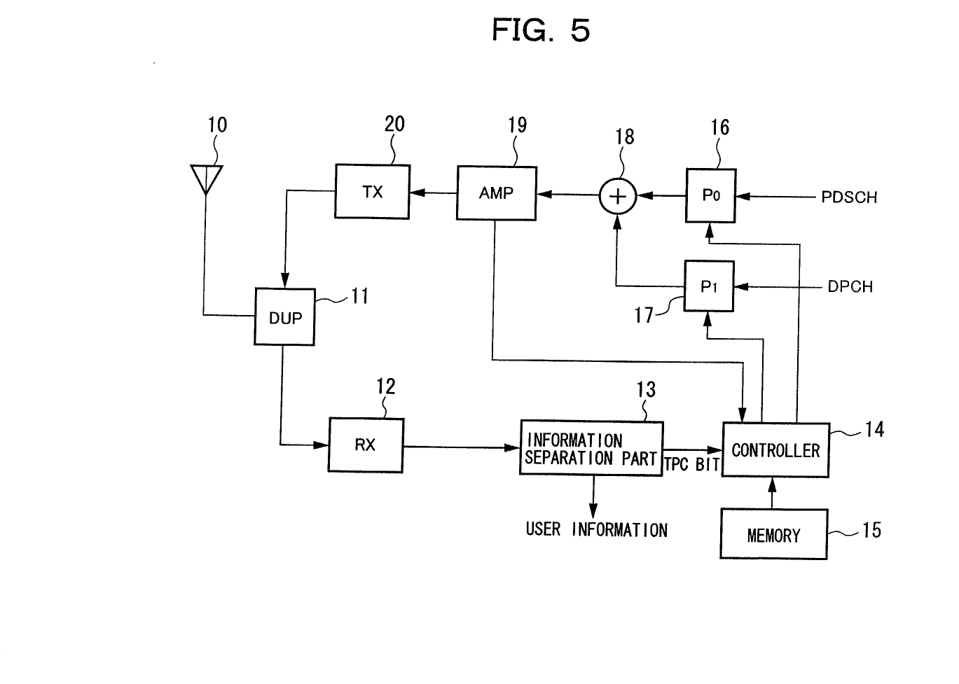

FIG. 5 is a block diagram for showing an example of the base station for realizing the operation of the present invention described above. A received signal from an antenna 10 is entered to the receiver (RX) through a duplexer (DUP) 11 for transmission and reception, and is supplied for an information separator 13 after processes such as demodulation in FIG. 5. The information separator 13 separates user information from different types of control information. A TPC (Transmission Power Control) bit from the control information is provided for a controller 14.

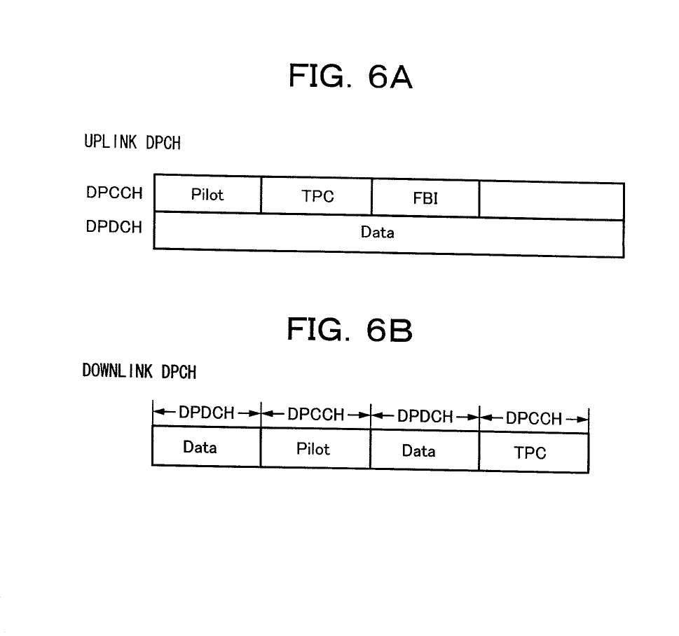

The following section describes the TPC bit. Formats for the DPCH are shown in FIG. 6A and FIG. 6B, and the downlink and the uplink have different formats. The uplink DPCH comprises DPCCH (Dedicated Physical Control Channel), and DPDCH (Dedicated Physical Data Channel), and they are quadrature-modulated with each other. The DPCCH includes a pilot signal (individual), the transmission power control bit (the TPC bit), feedback information (FBI), and communication data. The TPC bit is information for controlling the transmission power for downlink DPCH from the base station to the mobile station, and instructs the base station to increase/decrease the transmission power for downlink DPCH according to a measured result of measuring a receiving quality of the downlink DPCH. The TPC bit is extracted from the uplink DPCH, and is supplied for the controller 14.

The downlink DPCH comprises communication data, a pilot signal, and a TPC bit.

The PDSCH is multiplied by a coefficient P0 at a coefficient multiplier 16, the DPCH is multiplied by a coefficient P1 at a coefficient multiplier 17, and both of them are added at an adder 18. An amplifier 19 amplifies an output from this addition, and a transmitter 20 applies processes such as modulation to the output, and the output is transmitted through the DUP 11 and the antenna 10.

A value for the amplified power from the amplifier 19 is supplied for the controller 14, and indicates a current transmission power. The controller 14 determines the coefficient P1 according to the TPC bit for controlling the transmission power for DPCH, and determines the coefficient P0 according to the transmission power from the amplifier 19 for controlling the transmission power for PDSCH. This control form follows the flowchart shown in FIG. 4, and a CPU (a computer) reads and executes a control program stored in a dedicated memory 15 in advance for realizing this operation control.

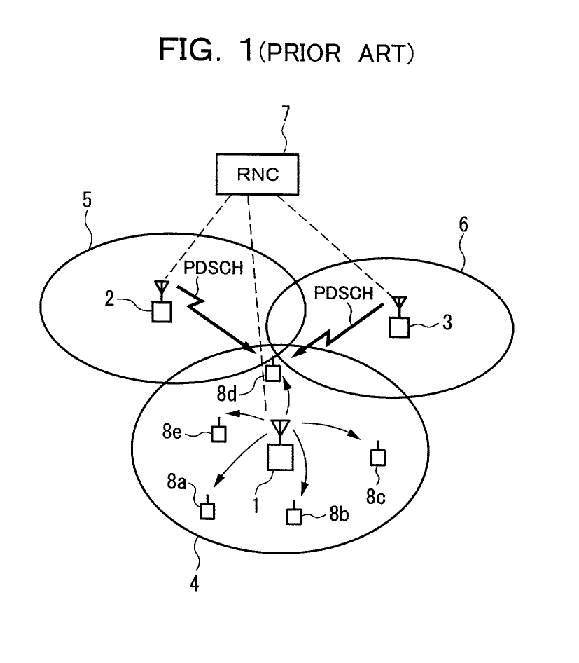

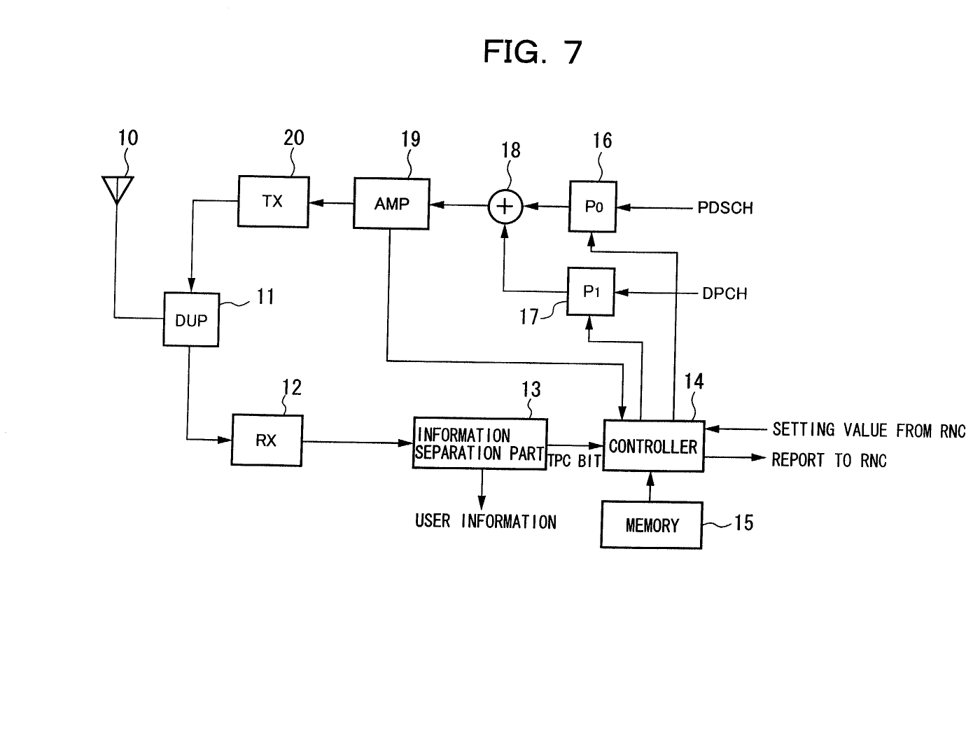

FIG. 7 is a block diagram for the base station of an alternative embodiment of the present invention, and shows parts equal to those in FIG. 5 with the same numerals. While the transmission power is controlled only in the base station in embodiment shown in FIG. 5, the base station control station (RNC) 7 shown in FIG. 1 as well as the base station control the transmission power in embodiment shown in FIG. 7.

Namely, the controller 14 reports the transmission power information from the amplifier 19 to the RNC 7 (see FIG. 1), and the RNC 7 which receives the report obtains the coefficient P0 for determining the transmission power for PDSCH based on this information, and notifies the controller 14 in base station of it.

As described above, because the entire transmission power for frequency carriers is constant in the present invention, an interference wave power received from neighboring cells is constant, when the transmission power for HS-PDSCH is set, an average data transfer rate which can be transmitted with this transmission power is approximately constant, and the prediction precision increases. Accumulating measured values such as a data transfer rate at 10W, and a data transfer rate at 12W enables the prediction. Thus, because a lower limit for a real data transfer rate increases, an effect that the number of users in the service quality assurance type service increases is provided.

Also, because it is not necessary to statically reserve a transmission power for the DPCH corresponding to a potential DPCH to be set, it is possible to increase the transmission power for HS-PDSCH when the usage of DPCH is low. Thus, an effect that the average data transfer rate increases is provided. When a best effort type service is provided, the transfer rate can increase, and a delay time can decrease.

What is claimed is:

1. A mobile communication system comprising:
a base station;
a mobile station having either one of or both of an individual channel set to said base station, and a shared channel set to said base station shared with other mobile stations for transmitting data from said base station; and
a transmission power control device for controlling a sum of transmission powers from said base station to said mobile stations to approximately constant.

2. The mobile communication system according to claim 1, wherein said transmission power control device maintains a sum of transmission powers for said shared channel, and for said individual channels at said constant power.

3. The mobile communication system according to claim 1, wherein said transmission power control device sets the transmission power for said shared channel to said constant power when there exists no individual channel.

4. The mobile communication system according to claim 1, wherein said transmission power control device respectively increases/decreases the transmission power for said shared channel according to an increased/decreased transmission power because of an increase/decrease of said individual channels.

5. The mobile communication system according to claim 4, wherein said transmission power control device respectively increases/decreases the transmission power for said shared channel by an average transmission power of the individual channels for an increase/decrease of one individual channel.

6. The mobile communication system according to claim 1, wherein if the sum of said transmission powers is larger than an upper limit, said transmission power control device decreases the transmission power for said shared channel by a difference between said sum and said upper limit.

7. The mobile communication system according to claim 1, wherein if the sum of said transmission powers is lower than a lower limit, said transmission power control device increases the transmission power for said shared channel by a difference between said sum and said lower limit.

8. The mobile communication system according to claim 1, wherein said transmission power control device is provided in said base station.

9. The mobile communication system according to claim 1, further comprising a base station control station for controlling said base station, wherein said base station reports information for said transmission power control to said base station control station, and said base station control station notifies setting information on the transmission power for said shared channel based on the reported information.

10. A transmission power control method for a base station of a mobile communication system including a base station, and a mobile station having either one of or both of an individual channel set to said base station, and a shared channel set to said base station shared with other mobile stations for transmitting data from said base station,
said method comprising,
a transmission power control step for controlling a sum of transmission powers from said base station to said mobile stations to approximately constant.

11. The transmission power control method according to claim 10 wherein said transmission power control step maintains a sum of transmission powers for said shared channel, and for said individual channels at said constant power.

12. The transmission power control method according to claim 10, wherein said transmission power control step sets the transmission power for said shared channel to said constant power when there exists no individual channel.

13. The transmission power control method according to claim 10, wherein said transmission power control step respectively increases/decreases the transmission power for said shared channel according to an increased/decreased transmission power because of an increase/decrease of said individual channels.

14. The transmission power control method according to claim 13, wherein said transmission power control step respectively increases/decreases the transmission power for said shared channel by an average transmission power of the individual channels for an increase/decrease of one individual channel.

15. The transmission power control method according to claim 10, wherein if the sum of said transmission powers is larger than an upper limit, said transmission power control step decreases the transmission power for said shared channel by a difference between said sum and said upper limit.

16. The transmission power control method according to claim 10, wherein if the sum of said transmission powers is lower than a lower limit, said transmission power control step increases the transmission power for said shared channel by a difference between said sum and said lower limit.

17. The transmission power control method according to claim 10, wherein said transmission power control step is conducted in said base station.

18. The transmission power control method according to claim 10, wherein the mobile communication system further comprises a base station control station for controlling said base station, further comprising steps of:
reporting information for said transmission power control to said base station control station in said base station;
notifying setting information on the transmission power for said shared channel based on the reported information in said base station control station; and
conducting said transmission power control according to this notified information in said base station.

19. A base station for setting either one of or both of an individual channel with a mobile station and a shared channel shared with other mobile stations for transmitting data from the mobile station, comprising;
a transmission power control device for controlling a sum of said transmission powers to said mobile stations to approximately constant.

20. The base station according to claim 19, wherein said transmission power control device maintains a sum of transmission powers for said shared channel, and for said individual channels at said constant power.

21. The base station according to claim 19, wherein said transmission power control device sets the transmission power for said shared channel to said constant power when there exists no individual channel.

22. The base station according to claim 19, wherein said transmission power control device respectively increases/decreases the transmission power for said shared channel according to an increased/decreased transmission power because of an increase/decrease of said individual channels.

23. The base station according to claim 22, wherein said transmission power control device respectively increases/decreases the transmission power for said shared channel by an average transmission power of the individual channels for an increase/decrease of one individual channel.

24. The base station according to claim 19, wherein if the sum of said transmission powers is larger than an upper limit, said transmission power control device decreases the transmission power for said shared channel by a difference between said sum and said upper limit.

25. The base station according to any one of claim 19, wherein if the sum of said transmission powers is lower than a lower limit, said transmission power control device increases the transmission power for said shared channel by a difference between said sum and the lower limit.

26. A program for making a computer execute a process for a transmission power control method for a base station of a mobile communication system including a base station, and a mobile station having either one of or both of an individual channel set to said base station, and a shared channel set to said base station shared with other mobile stations for transmitting data from said base station comprising a transmission power control step for controlling a sum of transmission powers from said base station to said mobile stations to approximately constant.

27. The program according to claim 26, wherein said transmission power control step maintains a sum of transmission powers for said shared channel, and for said individual channels at said constant power.

28. The program according to claim 26, wherein said transmission power control step sets the transmission power for said shared channel to said constant power when there exists no individual channel.

29. The program according to claim 26, wherein said transmission power control step respectively increases/decreases the transmission power for said shared channel according to an increased/decreased transmission power because of an increase/decrease of said individual channels.

30. The program according to claim 29, wherein said transmission power control step respectively increases/decreases the transmission power for said shared channel by an average transmission power of the individual channels for an increase/decrease of one individual channel.

31. The program according to claim 26, wherein if the sum of said transmission powers is larger than an upper limit, said transmission power control step decreases the transmission power for said shared channel by a difference between said sum and said upper limit.

32. The program according to claim 26, wherein if the sum of said transmission powers is lower than a lower limit, said transmission power control step increases the transmission power for said shared channel by a difference between said sum and said lower limit.
